(19) United States
(12) Patent Application Publication
(10) Pub. No.: US 2024/0308547 A1
(43) Pub. Date: Sep. 19, 2024

(54) DISPATCHING AUTONOMOUS VEHICLES TO THREE-DIMENSIONAL LOCATIONS

(71) Applicant: GM Cruise Holdings LLC, San Francisco, CA (US)

(72) Inventors: Michael Rusignola, Burlingame, CA (US); Armin Mahmoudi, Los Gatos, CA (US); Jun Zhou, San Francisco, CA (US); Ritwik Devasish Roy, Sinking Spring, PA (US)

(21) Appl. No.: 18/185,793

(22) Filed: Mar. 17, 2023

(51) Int. Cl. B60W 60/00; G06V 20/56

(52) U.S. Cl. CPC B60W 60/0025; G06V 20/56; B60W 2552/00; B60W 2554/4029

(57) ABSTRACT

The present disclosure generally relates to routing an AV to a three-dimensional location based on one or more rules and the longitudinal coordinate, the latitudinal coordinate, and the altitude parameter of the location. A method for determining, based on a longitudinal coordinate, a latitudinal coordinate, and an altitude parameter of the location, a route for an autonomous vehicle (AV) to travel to the location; determining one or more rules for vehicles in the multi-level structure based on at least one of a characteristic of a scene within the multi-level structure determined based on sensor data collected by the AV and one or more features of the scene determined based on the sensor data, and routing the AV to the location based on the one or more rules and the longitudinal coordinate, the latitudinal coordinate, and the altitude parameter of the location. Systems and machine-readable media are also provided.

### BACKGROUND

### 1. Technical Field

The present disclosure generally relates to navigating a three-dimensional location using an autonomous vehicle (AV) and, more specifically, for routing an AV to a three-dimensional location based on one or more rules and the longitudinal coordinate, the latitudinal coordinate, and the altitude parameter of the location.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a perspective view of an example autonomous vehicle (AV) travelling to pick up a passenger waiting on a level of a three-dimensional location, according to some examples of the present disclosure;

FIG. 2 illustrates a flow diagram of an example method for navigating a three-dimensional location using an AV, according to some examples of the present disclosure;

FIG. 3 illustrates a flow diagram of an example method for routing an AV to a three-dimensional location based on one or more rules and the longitudinal coordinate, the latitudinal coordinate, and the altitude parameter of the location, according to some examples of the present disclosure;

FIG. 4 illustrates an example of a deep learning neural network that can be used for routing an AV to a three-dimensional location based on a longitudinal coordinate, a latitudinal coordinate, and an altitude parameter of the location, according to some aspects of the disclosed technology;

FIG. 5 illustrates an example system environment that can be used to facilitate autonomous vehicle (AV) dispatch and operations, according to some aspects of the disclosed technology;

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicles (AVs) can navigate roadways without a human driver based on sensor signals generated by multiple sensor systems, as discussed in more detail below. In some examples, AVs can be used to perform many of the same functions currently performed by vehicles operated by human drivers. For example, AVs can provide ride-hailing services (e.g., ridesharing services), delivery services, remote/roadside assistance services, street services (e.g., street mapping, street patrol, street cleaning, street metering, parking reservation, etc.), and many others. In some examples, it can be advantageous to perform these functions using an AV rather than human operated vehicles in order to save costs and increase efficiency. For example, it may be advantageous to use AVs to provide ride-hailing services for passengers wishing to be transported from one location to a second location.

AVs can be equipped with a ride-hailing platform that can interact with a customer of a ride-hailing service via a ride-hailing application executing on a client computing device. The AV's ride-hailing platform can receive requests to pick up or drop off from the ride-hailing application and dispatch the AV for the trip. In some examples, the request to pick up a passenger can include the current latitudinal and longitudinal coordinates of the passenger wishing to be picked up. In this scenario, the AV's computing system can determine a route for the AV to travel to reach the current latitudinal and longitudinal coordinates of the passenger and subsequently navigate the AV to that location. In some examples, the computing system of the AV can dynamically reroute the AV to avoid unexpected obstacles encountered along the way (e.g., a closed roadway, a car accident blocking a roadway, etc.) and continue to the destination latitudinal and longitudinal coordinates via the new route.

In some examples, a passenger that has requested to be picked up by the AV using the ride-hailing application can be located at a three-dimensional location. In some examples, a three-dimensional location can be a location with more than one level (e.g., each at a different altitude), with each level having the same, substantially similar, or at least partly overlapping latitudinal and longitudinal coordinates. Some examples of three-dimensional locations can include, but are not limited to, multi-story parking garages, airports (e.g., airport roads/lanes such as departure and arrival roads/lanes, airport garages, etc.), bridges (e.g., multi-story bridges), and roadway overpasses. In each of these examples, there are multiple levels with the same or similar (e.g., at least partially overlapping) latitudinal and longitudinal coordinates, but with different altitudes. For example, a person standing on the ground floor of a multi-story parking garage can be located at the same latitudinal and longitudinal coordinates as a person standing on the second level of the same multi-story parking garage, even though they are not standing at the same location. In this example, while both people are located at the same latitudinal and longitudinal coordinates, they are located at different altitudes.

In some examples, when the AV is dispatched to pick up a passenger that is located in a three-dimensional location, the AV can navigate to the latitudinal and longitudinal coordinates, but may need a human driver to navigate to the level where the passenger is located. For example, in the scenario where the passenger is waiting to be picked up on a level within a multi-story parking garage, the AV can navigate to the entrance of the multi-story parking garage, but may need a human driver to navigate within the multi-story parking garage (e.g., navigate the levels of the multi-story parking garage) to the location of the waiting passenger, including the altitude and/or level, the latitudinal coordinates, and the longitudinal coordinates of the waiting passenger. Therefore, there exists a need for the AV to understand not only the latitudinal and longitudinal coordinates of a destination (e.g., the X and Y coordinates), but also for the AV to understand the altitude of the destination (e.g., the Z coordinate). Further, once the AV understands the X, Y, and Z location of its destination, there exists a need for the AV to navigate to the X, Y, and Z location of its destination.

In some examples, to navigate to the X, Y, and Z location of an AV's destination, the AV may need to understand the layout and traffic rules (among other considerations) related to the three-dimensional location. In the example of the multi-story parking garage, once the AV knows the three-dimensional location of its destination (e.g., the X, Y, and Z coordinates), the AV can properly navigate to that destination within the multi-story garage. In some examples, proper navigation within the multi-story garage can include understanding which ramps to traverse (and the direction that traffic flows on a given ramp). In some examples, navigating a multi-story garage can also increase the expected time of arrival (ETA) of the AV to the passenger (e.g., relative to navigating a single-story garage), and therefore understanding the layout of the multi-story garage where the passenger is waiting can assist in providing the passenger with a more accurate ETA. In some examples, a more accurate ETA will also result in more accurate pricing for a ride-hailing service. In the scenario where the AV intends to park at a destination within a multi-story garage, the AV can be aware of parking restrictions within the multi-story garage (e.g., reserved parking spots, parking spots with restricted hours, etc.), and therefore reroute to a new parking spot if needed based on these restrictions.

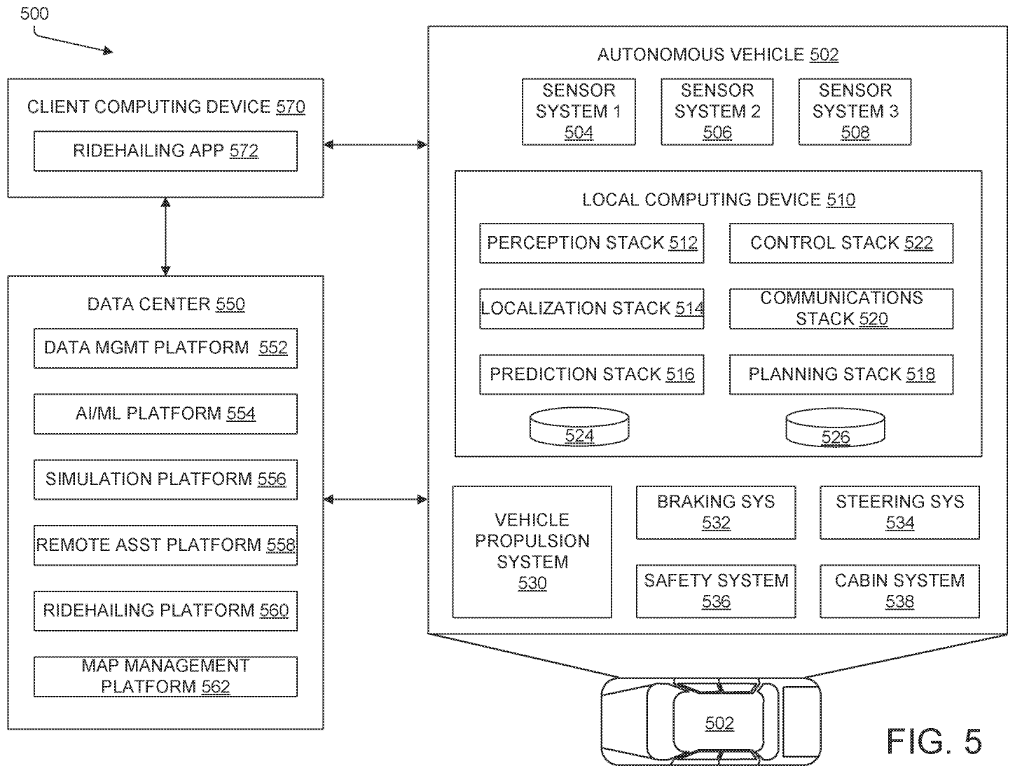

In some examples, this additional information (e.g., the Z altitude location, ramp layout, parking restrictions, etc.) can be included in the AV's HD maps stored within the AV's HD geospatial database, as explained in more detail below. The HD geospatial database can store HD maps and related data of the streets and other locations upon which the AV travels. In some examples, the HD maps and related data can comprise multiple layers, such as an areas layer, a lanes and boundaries layer, an intersections layer, a traffic controls layer, and so forth. In some examples, an additional layer can be added to the AV's HD maps that includes the information used for navigating three-dimensional locations such as parking garages, airports, etc. For example, the map can include data regarding the location and traffic direction of each ramp within a multi-story parking garage, which the AV can use to navigate within the multi-story parking garage. Further, in some examples, each level of a three-dimensional location can be designated with a discreet value (e.g., “level 1,” “level 2,” etc.) in the map layer rather than a measured height (or in addition to a measured height/altitude). In some examples, this discreet value can be termed an altitude parameter. In some examples, the AV can be equipped with a sensor, such as an altimeter and/or an inertial measurement unit, that can detect the AV's change in altitude as it travels. In some examples, the AV's computer system (e.g., local computing device 510 shown in FIG. 5) can keep track of these detected changes in altitude to determine the “level” where the AV is currently located (e.g., in three-dimensional space and/or relative to a reference point such as a sea level, a first level, and/or a ground level for example) based on the change in altitude. The AV can be equipped with any known sensors or detectors that can track and/or determine (and/or be used to track and/or determine) the AV's altitude with respect to a reference point such as a sea level or a ground level. In some examples, any restrictions related to the three-dimensional location that are not included in the map layer can be dynamically determined by the AV using one or more sensors (e.g., a camera sensor, an IMU, an altimeter, a light detection and ranging sensor, a radio detection and ranging sensor, etc.) mounted about the AV. While the examples above are mostly directed to the multi-story garage example, it is understood that the same methods can be used to route and navigate an AV to any three-dimensional location (including, but not limited to, airports, bridges, and roadway overpasses).

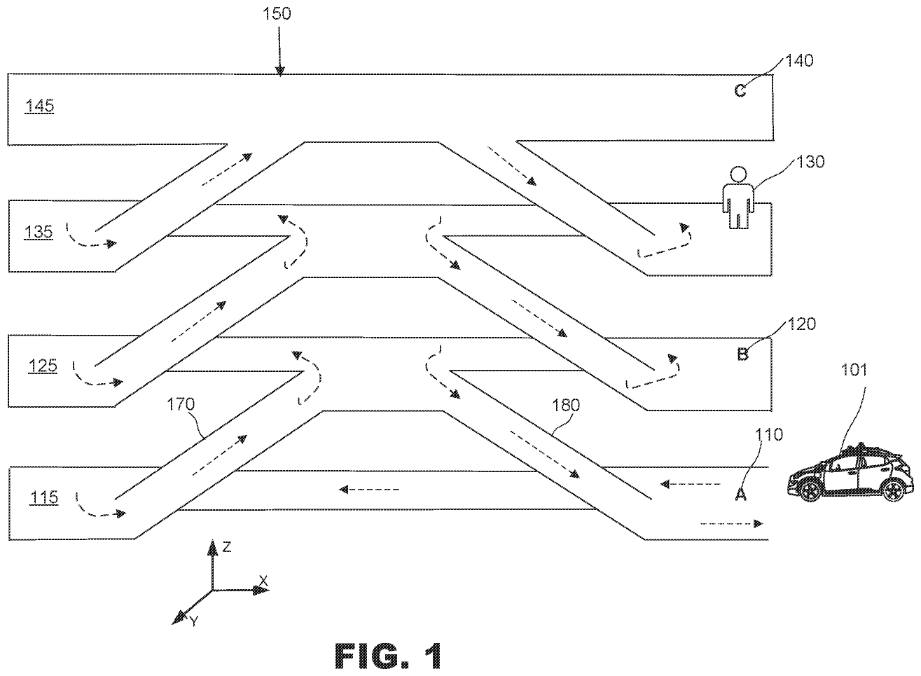

FIG. 1 illustrates a perspective view of an example AV 101 en route to pick up passenger 130 waiting on level 135 of three-dimensional structure 150. As illustrated in FIG. 1, three-dimensional structure 150 comprises four discreet levels (e.g., ground level 115, level 125, level 135, and top level 145). Although FIG. 1 illustrates three-dimensional structure 150 comprising four levels, this is merely an example three-dimensional structure provided for explanation purposes and it is contemplated that the methods described herein are applicable to any three-dimensional structure with any number of levels. Further, three-dimensional structure 150 comprises multiple directional ramps (for example, ramp 170 and ramp 180). The dotted arrows throughout three-dimensional structure 150 indicate the direction of traffic within three-dimensional structure 150. In the scenario depicted in FIG. 1, passenger 130 has requested an AV (e.g., AV 101) to pick up passenger 130 at a current location of passenger 130 within three-dimensional structure 150. In some examples, passenger 130 can use a ride-hailing application executing on a client computing device to request an AV (e.g., AV 101) for pick up. AV 101's ride-hailing platform can receive the request to pick up from passenger 130's ride-hailing application and dispatch AV 101 to pick up passenger 130. The AV 102 can represent any vehicle with autonomous driving (e.g., self driving) capabilities. An example AV and AV environment that can be used to implement AV 101 (and/or can provide an example of AV 101) is illustrated in FIG. 5 and described below with respect to FIG. 5. For example, in some cases, AV 101 can be the same as or similar to AV 502 described below with respect to FIG. 5.

In the example shown in FIG. 1, the latitudinal and longitudinal coordinates (e.g., X and Y directions shown in FIG. 1) of passenger 130 are the same latitudinal and longitudinal coordinates of location A 110, location B 120, and location C 140. That is, the location of passenger 130, location A 110, location B 120, and location C 140 all share the same X and Y coordinates, but each (e.g., the location of passenger 130, location A 110, location B 120, and location C 140) is located at a different altitude (e.g., Z direction), on a different level of three-dimensional structure 150. In some examples, the AV 101 can determine and/or understand not only the X and Y coordinates of passenger 130 but also the Z coordinate of passenger 130 in order to arrive at the correct location within three-dimensional structure 150, where passenger 130 is waiting (rather than above or below the location of passenger 130). For example, in this scenario, if AV 101 is only aware of the X and Y coordinates of passenger 130's location, the AV 101 would likely approach and stop at location A 110 on ground level 115 for passenger 130. However, since passenger 130 is not located at location A 110, the AV 101 would not find passenger 130 at location A 110 and may not properly fulfill passenger 130's request for pick up.

In some examples, an additional layer can be added to the AV 101's HD maps that includes the height (e.g., Z) information used for routing AV 101 in three-dimensional locations such as three-dimensional structure 150. In some examples, the Z locations can be added to the AV 101's HD maps as discreet values. For example, level 115, level 125, level 135, and level 145 illustrated in FIG. 1 can each be added to a layer of AV 101's HD maps as an altitude parameter. To illustrate, level 115 can be added to a layer of AV 101's HD maps as an altitude parameter with a value of 0; level 125 can be added to a layer of AV 101's HD maps as an altitude parameter with a value of 1; level 135 can be added to a layer of AV 101's HD maps as an altitude parameter with a value of 2; and level 145 can be added to a layer of AV 101's HD maps as an altitude parameter with a value of 3. In the example illustrated in FIG. 1, when passenger 130 requests an AV (e.g., AV 101) for a pick up using a ride-hailing application, AV 101's ride-hailing platform can receive the latitudinal and longitudinal coordinates of passenger 130's location (e.g., the X and Y coordinates), as well as an altitude parameter of passenger 130's location (e.g., the Z coordinate). In the example illustrated in FIG. 1, since passenger 130 is located on level 135, the request for pick up can include the latitudinal and longitudinal coordinates of passenger 130's location (e.g., the X and Y coordinates), and also the altitude parameter of passenger 130's location (e.g., level 135 can be associated with altitude parameter 2 as discussed above). In some examples, because AV 101's HD maps include layout information of the three-dimensional structure 150, AV 101's computer system can determine a path for AV 101 to travel within three-dimensional structure 150 based on the location of the received altitude parameter (together with the latitudinal and longitudinal coordinates) within AV 101's HD map.

In some aspects, the request for pick up from passenger 130 can include the latitudinal and longitudinal coordinates of passenger 130 and a level of three-dimensional structure 150 where passenger 130 is located. In some cases, AV 101 can understand or interpret the level provided in the request in order to navigate to the correct location of passenger 130 within three-dimensional structure 150. In other cases, AV 101 can translate the level provided in the request to other information that AV 101 can understand and use to navigate to the correct location of passenger 130 within three-dimensional structure 150. For example, AV 101 can interpret the level provided in the request to a coordinate in three-dimensional space and/or an altitude value (e.g., relative to a sea level, a first or ground floor of three-dimensional structure 150, a ground in an environment associated with three-dimensional structure 150, a ground level in a map used by AV 101 to navigate an environment associated with three-dimensional structure 150, and/or relative to any other reference point or frame of reference), which AV 101 can use to navigate to the correct location of passenger 130 within three-dimensional structure 150. In other cases, the request for pick up from passenger 130 can instead include the altitude or height of passenger 130 (e.g., in addition to the latitudinal and longitudinal coordinates of passenger 130), and AV 101 can translate the altitude or height of passenger 130 to a level within three-dimensional structure 150 and use the level (e.g., in addition to the latitudinal and longitudinal coordinates of passenger 130) translated from the altitude or height to navigate to the correct location of passenger 130 within three-dimensional structure 150.

AV 101's HD maps can also include semantic data related to the layout, rules, and restrictions (among other data) of three-dimensional structure 150. For example, AV 101's HD maps can include data indicating that a directionality of ramp 170 is in the up direction (e.g., in the direction of travel used to navigate towards the highest and/or higher levels of three-dimensional structure 150), while a directionality of ramp 180 is in the down direction (e.g., in the direction of travel used to navigate towards the lowest and/or lower levels of three-dimensional structure 150). Therefore, AV 101's computer system can determine a route that navigates the ramps in the correct directions as AV approaches its destination. In the example illustrated in FIG. 1, AV 101's computer system can correctly direct AV 101 passed ramp 180, and up ramp 170 as it proceeds to passenger 130 on level 135. Therefore, in the example illustrated in FIG. 1, passenger 130 can request a pick from AV 101 by providing the passenger 130's location (e.g., X, Y, and Z), and AV 101 can navigate to passenger 130's location by following the rules associated with three-dimensional structure 150. In some examples, in some indoor environments, the localization stack can determine the AV 101's position and orientation (pose) using different methods from multiple systems (e.g., GPS, IMUs, cameras, LIDAR, RADAR, ultrasonic sensors, the HD geospatial database, etc.). For example, in some cases, the AV 101 can compare sensor data captured in real-time by the sensor systems to data in the HD geospatial database to determine its precise (e.g., accurate to the order of a few centimeters or less) position and orientation.

Three-dimensional structure 150 can represent any three-dimensional space and/or structure such as, for example and without limitation, a multi-level garage, a multi-level building, a multi-level airport, a multi-level tunnel, a road and an overpass or bridge, a multi-level bridge, and/or any other three-dimensional space and/or structure. Moreover, the method described above is applicable to any situation where an AV navigates to a three-dimensional location. For example, rather than picking up passenger 130, AV 101 can be requested to park at a location within three-dimensional structure 150, such as location B 120. Since location B 120 is not located on the ground floor, AV 101's computer system can interpret an altitude parameter (together with the latitudinal and longitudinal coordinates) to understand where it should park. In some examples, AV 101's HD maps can also include semantic data related to parking restrictions within three-dimensional structure 150. For example, the parking spot located at location B 120 can be designated for a certain vehicle(s) only (e.g., port authority vehicles), and this data can be included in AV 101's HD maps. In this scenario where AV 101 has been requested to park at a location that is reserved for port authority vehicles (e.g., location B 120), AV 101's controller can instead navigate AV 101 to a different parking spot (e.g., location C 140) that is available for public parking. Any other types of restrictions on parking can also be included in AV 101's HD maps semantic data, such as handicapped locations, hours restrictions, compact car only spots, etc. In some examples, a restriction may not be mapped ahead of time, and AV 101 can dynamically determine that parking restrictions exist at a location using the mounted sensor systems of the AV 101. For example, AV 101 can determine, based on sensor data measuring and/or depicting one or more characteristics (e.g., a behavior, a pose, a pattern, a flow or directionality, a configuration, motion, etc.) of one or more vehicles in a scene (e.g., three-dimensional structure 150) and/or one or more scene elements (e.g., a human traffic controller, a sign, a semantic feature, a sidewalk, a crosswalk, an intersection, a traffic cone, a blocked/restricted area, a parking meter, a booth, a pedestrian, etc.), one or more restrictions and/or rules for traffic in the scene.

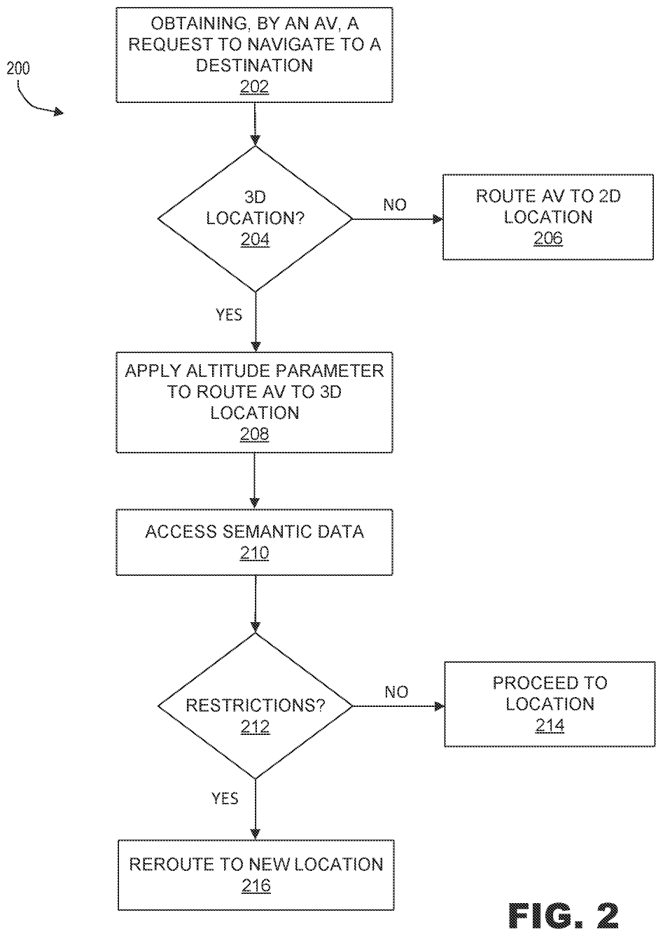

FIG. 2 illustrates a flow diagram of an example process 200 for navigating to a three-dimensional location using an AV. At block 202, the process 200 can include obtaining, by AV 101, a request to navigate to a destination. In some examples, the request can include latitudinal and longitudinal coordinates of the destination. In some examples, the request can additionally include an altitude or height of the destination and/or a level of the destination within a three-dimensional space and/or structure. In some cases, the destination can include a location within a multi-level structure (e.g., three-dimensional structure 150). In some examples, the AV 101 can be requested to pick up a passenger at the destination by way of a ride-hailing application. For example, the request to navigate to the destination can be provided through a ride-hailing application on a client device. In some examples, the AV 101 can be requested to deliver a package to the destination. The process 200 provided herein is applicable to dispatching an AV (e.g., AV 101) to any destination within a three-dimensional structure for any reason and/or parking the AV at the destination within the three-dimensional structure.

At block 204, the process 200 can include determining whether the destination is a three-dimensional location. In some examples, when AV 101 receives the request to travel to the destination, the AV 101's computer system (e.g., local computing device 510 shown in FIG. 5) can determine, based on the request and/or map data, whether the destination is a three-dimensional location.

For example, AV 101 can determine that the destination is a three-dimensional location based on an indication of an altitude or height of the destination included in the request and/or the map data, an indication of a level included in the request and/or the map data, semantic information associated with the destination (e.g., semantic information indicating that the destination is a parking spot within a three-dimensional structure, a stop within the three-dimensional structure, a ride-hailing pick up spot within a three-dimensional structure, within a proximity to a semantic object and/or scene element, etc.), and/or an indication that the destination is a three-dimensional location specified in the request and/or included in the map data. To illustrate, AV 101 can determine a semantic meaning of an object and/or area associated with the destination based on map data and/or destination information in the request. The semantic meaning of the object and/or area can be used to determine that the destination is a three-dimensional location and, in some cases, an altitude/height and/or level associated with the destination. For example, if the request indicates that the destination is at parking spot 520, AV 101 may determine (e.g., based on map data and/or other data) that parking spot 520 is at a 5^{th} level of a three-dimensional structure and thus the destination is a three-dimensional location. If the request indicates that the destination is at the blue zone within a three-dimensional structure, AV 101 may determine (e.g., based on map data and/or other data) that the blue zone at a 4^{th} level of a three-dimensional structure and thus the destination is a three-dimensional location. If the request indicates that the destination is at a lane for departures within a three-dimensional transportation structure (e.g., an airport, a train station, a bus station, etc.), AV 101 may determine (e.g., based on map data and/or other data) that the departures lane is at a 2^{nd} level of the three-dimensional transportation structure and thus the destination is a three-dimensional location.

As another example, AV 101 can determine that the destination is not a three-dimensional location based on an absence of any indication (or a particular type of indication) of an altitude or height of the destination in the request and/or in the map data, an absence of any indication (or a particular type of indication) of a level in the request and/or the map data, and/or an absence of any indication that the destination is a three-dimensional location specified in the request and/or the map data.

If AV 101's computer system determines that the destination is not a three-dimensional location, at block 206, AV 101's computer system can determine the route to the destination and navigate AV 101 to the destination using sensor data collected by one or more sensors of AV 101. The sensor data can include, for example and without limitation, image data from one or more camera sensors, LIDAR data from one or more LIDAR sensors, radar data from one or more RADAR sensors, measurements from one or more IMUs, data from one or more infrared (IR) sensors, data from one or more acoustic sensors (e.g., ultrasonic sensors, microphones, etc.), global positioning system (GPS) data, accelerometer data, data from one or more time-of-flight sensors, and/or data from any other sensor(s).

At block 208, if AV 101's computer system determines that the destination is a three-dimensional location (e.g., a location within three-dimensional space and/or within a three-dimensional structure such as three-dimensional structure 150), AV 101's computer system can apply an altitude parameter of the destination and route AV 101 to the three-dimensional location of the destination. In some examples, the altitude parameter can include an indication of an altitude or a height of the destination specified in the request and/or the map data. In other examples, the altitude parameter can additionally or alternatively include an indication of a level/floor of the destination specified in the request and/or the map data. As discussed above, an additional layer can be added to the AV 101's HD maps that includes the altitude/height (e.g., Z) information used by AV 101 to route in three-dimensional locations. In some examples, the altitude/height information (e.g., Z locations) can be added to the AV 101's HD maps as discreet values (e.g., altitude parameter). In some cases, the altitude/height information can be added with reference to one or more areas, objects, and/or semantic scene elements in the AV 101's HD maps.

In the example illustrated in FIG. 1, when passenger 130 requests an AV (e.g., AV 101) for a pick up using a ride-hailing application, AV 101's ride-hailing platform can receive both the latitudinal and longitudinal coordinates of passenger 130's location (e.g., the X and Y coordinates), and also an altitude parameter of passenger 130's location (e.g., the Z coordinate). As illustrated in FIG. 1, because passenger 130 is located on level 135, the request for pick up can include the latitudinal and longitudinal coordinates of passenger 130's location (e.g., the X and Y coordinates), and also the altitude parameter of passenger 130's location (e.g., level 135 can be associated with altitude parameter 2 as discussed above). Once AV 101's computer system understands that the destination is a three-dimensional location, it can route AV 101 to that destination (block 208).

In some examples, once AV 101 arrives at the entrance to the three-dimensional location (e.g., three-dimensional structure 150), AV 101 can proceed to navigate to the three-dimensional location (e.g., three-dimensional structure 150) of the destination and arrive at the destination within the three-dimensional location (e.g., three-dimensional structure 150). At block 210, the process 200 can include accessing semantic data and/or other map data in AV 101's HD maps related to navigating the three-dimensional location (e.g., the interior of three-dimensional structure 150, etc.), such as data indicating a directionality (e.g., a direction of travel for traffic) of one or more lanes and/or roads at the three-dimensional location (and/or an associated three-dimensional structure), indicating a directionality of one or more ramps at or near (e.g., within a proximity of) the three-dimensional location (and/or an associated three-dimensional structure), one or more rules (e.g., parking rules, navigation rules, yield and/or assert rules, ingress and/or egress rules, route rules, restrictions, etc.) for traffic at the three-dimensional location (and/or an associated three-dimensional structure), and/or other data used to navigate the three-dimensional location and/or an associated region. For example, as illustrate in FIG. 1, AV 101's HD maps can include data indicating that traffic using ramp 170 should travel in the up direction (e.g., in an upward direction and/or towards a highest and/or higher level/floor/location), and traffic using ramp 180 should travel in the down direction (e.g., in a downward direction and/or towards a lowest and/or lower level/floor/location). Therefore, AV 101's computing system can determine a route that navigates the ramps in the correct directions as AV 101 approaches its destination. In the example illustrated in FIG. 1, AV 101's computer system can correctly direct AV 101 passed ramp 180, and up ramp 170 as it proceeds to passenger 130 on level 135.

As AV 101 approaches the requested destination, it can be important for AV 101 to know whether there are any restrictions related to navigating, parking or stopping, and/or any other operations/behavior at the requested destination. For example, some three-dimensional locations can have restrictions related to accessible spaces (e.g., spaces/spots for people with disabilities such as handicapped spots, spaces/spots for pregnant women, spaces/spots for certain designated groups, etc.), specific hours of use, restrictions for specific hours (e.g., lane changes based on specific hours, parking restrictions for specific hours, etc.), compact vehicles only, electric vehicles only, etc. In some examples, restrictions on parking can also be included in AV 101's HD maps semantic data.

At block 212, the process 200 can include determining, by the AV 101's computer system, whether the requested destination includes any restrictions that would prevent the AV 101 from safely or legally stopping at the requested destination. If AV 101's controller determines that there are no restrictions (e.g., AV 101 is permitted to stop at the requested destination), at block 214, AV 101's computer system can continue to navigate AV 101 to the requested destination. However, if AV 101's computer system determines that there are restrictions (e.g., AV 101 is not permitted to stop at the requested destination), AV 101's computer system can reroute the AV to a new location (and notify the awaiting passenger if necessary). In some examples, as discussed above, a restriction may not be mapped ahead of time, and AV 101 can dynamically determine that parking restrictions exist at a location using the mounted sensor systems of the AV 101. For example, AV 101 can detect one or more restrictions based on image data, LIDAR data, RADAR data, IR data, GPS data, acoustic data, and/or other sensor data. For example, AV 101 can detect a traffic cone placed at or around a particular space based on one or more images of the space, and determine that the space is closed/restricted based on the detection of the traffic cone placed at or around the particular space. As another example, assume that a particular lane is mapped for traffic traveling in one direction at a particular range of times and mapped for traffic traveling in a different direction at a different range of times. AV 101 can collect one or more images and/or video frames depicting one or more vehicles traveling through the lane (and/or vehicles traveling through one or more adjacent lanes) and determine a directionality of that lane at a current time based on the direction of travel of the one or more vehicles. In this example, AV 101 can predict that directionality of the lane matches the direction of travel of any vehicles traveling in that lane or that the directionality of the lane is the opposite direction as the direction of travel of any vehicles traveling in an adjacent or opposite lane.

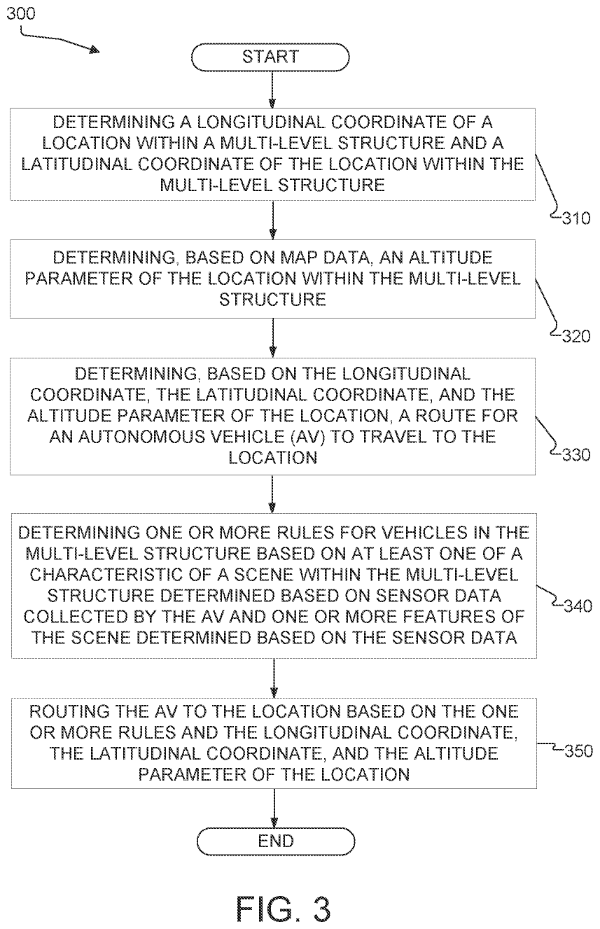

FIG. 3 illustrates a flow diagram of an example process 300 for routing an AV (e.g., AV 101) to a three-dimensional location based on one or more rules and the longitudinal coordinate, the latitudinal coordinate, and the altitude parameter of the location. At block 310, the process 300 can include determining a longitudinal coordinate of a location within a multi-level structure (e.g., three-dimensional structure 150) and a latitudinal coordinate of the location within the multi-level structure. As discussed above, AVs can be equipped with a ride-hailing platform that can interact with a customer of a ride-hailing service via a ride-hailing application executing on the client computing device. The AV 101's ride-hailing platform can receive requests to pick up or drop off passenger(s) and/or item(s). The ride-hailing platform can receive the requests from the ride-hailing application and dispatch the AV 101 for the trip. In some examples, the request to pick up a passenger (and/or an item) can include the latitudinal and longitudinal coordinates of the passenger (e.g., the current coordinates or future destination coordinates) wishing to be picked up. In this scenario, the AV 101's computing system can determine a route for the AV 101 to travel to reach the latitudinal and longitudinal coordinates of the passenger (and/or item) and subsequently navigate the AV 101 to that location. The process 300 provided herein is applicable to dispatching an AV (e.g., AV 101) to any destination within a three-dimensional space and/or a three-dimensional structure for any reason (e.g., delivering a package) and/or parking the AV at the destination within the three-dimensional structure.

At block 320, the process 300 can include determining, based on map data, an altitude parameter of the location within the multi-level structure. For example, each level of a three-dimensional location can be designated with a discreet value (e.g., “level 1,” “level 2,” etc.) in the map layer rather than a measured height (or in addition to a measured height/altitude). In some examples, this discreet value can be termed an altitude parameter. In some examples, an additional layer can be added to the AV 101's HD maps that includes the height (e.g., Z) information used for routing AV 101 in three-dimensional locations such as three-dimensional structure 150. In some examples, the Z locations can be added to the AV 101's HD maps as discreet values. For example, level 115, level 125, level 135, and level 145 illustrated in FIG. 1 can each be added to a layer of AV 101's HD maps as an altitude parameter. In the example illustrated in FIG. 1, when passenger 130 requests an AV (e.g., AV 101) for a pick up using a ride-hailing application, AV 101's ride-hailing platform can receive the latitudinal and longitudinal coordinates of passenger 130's location (e.g., the X and Y coordinates), as well as an altitude parameter of passenger 130's location (e.g., the Z coordinate). In the example illustrated in FIG. 1, since passenger 130 is located on level 135, the request for pick up can include the latitudinal and longitudinal coordinates of passenger 130's location (e.g., the X and Y coordinates), and also the altitude parameter of passenger 130's location (e.g., level 135 can be associated with altitude parameter 2 as discussed above).

As discussed above, in some examples, AV 101 can be equipped with a sensor(s), such as an altimeter and/or an inertial measurement unit, that can detect the AV's change in altitude as it travels. In some examples, the AV's computer system (e.g., local computing device 510 shown in FIG. 5) can keep track of these detected changes in altitude to determine the “level” where the AV is currently located (e.g., in three-dimensional space and/or relative to a reference point such as a sea level, a first level, and/or a ground level for example) based on the change in altitude. The AV can be equipped with any known sensors or detectors that can track and/or determine (and/or be used to track and/or determine) the AV's altitude with respect to a reference point such as a sea level or a ground level.

At block 330, the process 300 can include determining, based on the longitudinal coordinate, the latitudinal coordinate, and the altitude parameter of the location, a route for an autonomous vehicle (e.g., AV 101) to travel to the location. For example, when passenger 130 requests an AV (e.g., AV 101) for a pickup using a ride-hailing application, AV 101's ride-hailing platform can receive both the latitudinal and longitudinal coordinates of passenger 130's location (e.g., the X and Y coordinates), and also an altitude parameter of passenger 130's location (e.g., the Z coordinate). Once AV 101's computer system understands that the destination is a three-dimensional location, it can route AV 101 to that destination. For example, AV 101's computer system can apply an altitude parameter of the destination and route AV 101 to the three-dimensional location of the destination. In some examples, AV 101 can determine that the destination is a three-dimensional location based on the altitude parameter (and/or the combination of the altitude parameter, the latitudinal coordinate, and the longitudinal coordinate) associated with the destination. AV 101 can determine that if a destination includes an altitude parameter, such destination is a three-dimensional location with an associated height, altitude, and/or floor/level relative to AV 101, a ground and/or ground floor/level in a scene, a road in the scene, a sea level, objects (e.g., roads, intersections, ramps, sidewalks, road markings, traffic signs, vehicles, pedestrians, etc.) detected using sensor data and/or indicated in a map of AV 101 such as a semantic map and/or a navigation map, and/or any other reference point.

At block 340, the process 300 can include determining one or more rules for vehicles in the multi-level structure based on a characteristic of a scene within the multi-level structure determined based on sensor data collected by the AV and/or based on one or more features of the scene determined based on the sensor data. In some examples, as AV 101 approaches the requested destination, it can be important for AV 101 to know whether there are any restrictions related to navigating, parking or stopping, and/or any other operations/behavior at the requested destination. For example, some three-dimensional locations can have rules and/or restrictions related to accessible spaces (e.g., spaces/spots for people with disabilities such as handicapped spots, spaces/spots for pregnant women, spaces/spots for certain designated groups, etc.), specific hours of use, restrictions for specific hours (e.g., lane changes based on specific hours, parking restrictions for specific hours, etc.), compact vehicles only, electric vehicles only, etc. In some examples, restrictions on parking can also be included in AV 101's HD maps semantic data.

In some examples, AV 101's HD maps can include semantic data related to the layout, rules, and restrictions (among other data) of three-dimensional structure 150. For example, AV 101's HD maps can include data that ramp 170 is directional in the up direction, while ramp 180 is directional in the down direction. Therefore, AV 101's controller can determine a route that navigates the ramps in the correct directions as AV approaches its destination. In the example illustrated in FIG. 1, AV 101's computing system can correctly direct AV 101 passed ramp 180, and up ramp 170 as it proceeds to passenger 130 on level 135. Therefore, in the example illustrated in FIG. 1, passenger 130 can request a pick from AV 101 by providing the passenger 130's location (i.e., X, Y, and Z), and AV 101 can navigate to passenger 130's location by following the rules associated with three-dimensional structure 150.

At block 350, the process 300 can include routing the AV to the location based on the one or more rules and the longitudinal coordinate, the latitudinal coordinate, and the altitude parameter of the location. In some examples, to navigate to the X, Y, and Z location of an AV's destination, the AV may need to understand the layout and traffic rules (among other considerations) related to the three-dimensional location. In the example of the multi-story parking garage, once the AV knows the three-dimensional location of its destination (e.g., the X, Y, and Z coordinates), the AV can properly navigate to that destination within the multi-story garage. In some examples, proper navigation within the multi-story garage can include understanding which ramps to traverse (and the direction that traffic flows on a given ramp). In some examples, navigating a multi-story garage can also increase the expected time of arrival (ETA) of the AV to the passenger (e.g., relative to navigating a single-story garage), and therefore understanding the layout of the multi-story garage where the passenger is waiting can assist in providing the passenger with a more accurate ETA. For example, the AV can calculate a first ETA from a location of the AV to a point along the trip where the one or more rules associated with the three-dimensional location apply (e.g., an entrance of an associated three-dimensional structure, a point at which the AV transitions from an area described in a navigation and/or semantic map of the AV to a different map or to an unmapped area associated with the three-dimensional location, etc.). The AV can also calculate a second ETA from the point along the trip where the one or more rules apply to the destination, and calculate the total ETA of the AV to the destination based on the first ETA and the second ETA (e.g., by adding/combining the first and second ETAs). In some examples, to calculate the second ETA, the AV can calculate a distance from the point along the trip where the one or more rules apply to the destination, any expected delays along the way (e.g., stopping at an entry or ramp, etc.), and a predicted average speed from the point along the trip where the one or more rules apply to the destination, and determine the second ETA based on the distance, any expected delays, and/or the predicted average speed. In some examples, the AV can use the one or more rules to determine the predicted average speed. The one or more rules may indicate, for example, a speed limit associated with the three-dimensional location, a number of lanes available for vehicles to travel in a direction towards the destination from the perspective of an incoming direction of the AV, a number of stop and/or yield points along the way from that point to the destination, etc., which the AV can use to predict the average speed from that point to the destination.

In some examples, a more accurate ETA will also result in more accurate pricing for a ride-hailing service. In the scenario where the AV intends to park at a destination within a multi-story garage, the AV can be aware of parking rules and/or restrictions within the multi-story garage (e.g., reserved parking spots, parking spots with restricted hours, etc.), and therefore reroute to a new parking spot if needed based on these restrictions.

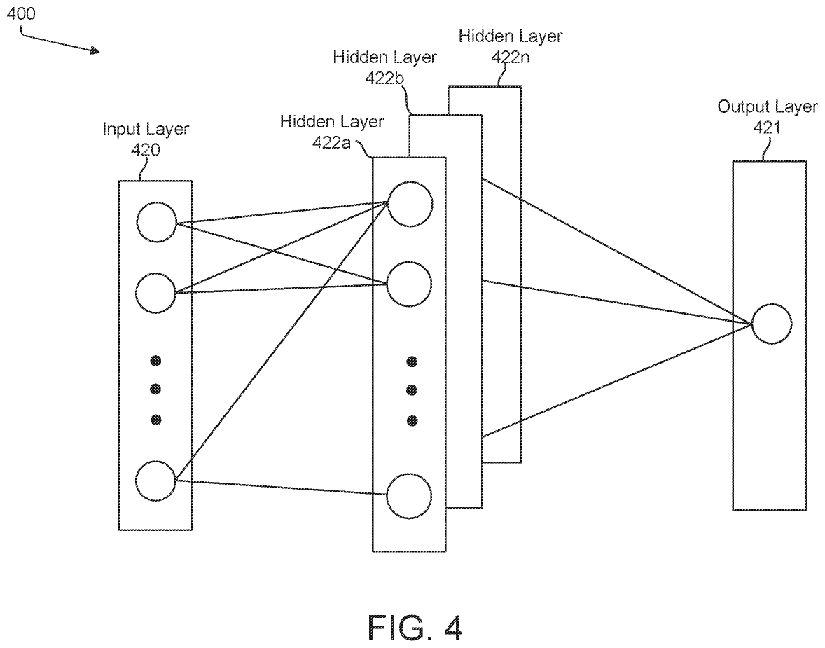

The disclosure now turns to a further discussion of models that can be implemented by the systems and techniques described herein. FIG. 4 is an example of a deep learning neural network 400 that can be used to implement all or a portion of the systems and techniques described herein (e.g., neural network 400 can be used to implement three-dimensional location mapping as discussed above). An input layer 420 can be configured to receive sensor data and/or data relating to an environment surrounding an AV. Neural network 400 includes multiple hidden layers 422a, 422b, through 422n. The hidden layers 422a, 422b, through 422n include “n” number of hidden layers, where “n” is an integer greater than or equal to one. The number of hidden layers can be made to include as many layers as needed for the given application. Neural network 400 further includes an output layer 421 that provides an output resulting from the processing performed by the hidden layers 422a, 422b, through 422n.

Neural network 400 is a multi-layer neural network of interconnected nodes. Each node can represent a piece of information. Information associated with the nodes is shared among the different layers and each layer retains information as information is processed. In some cases, the neural network 400 can include a feed-forward network, in which case there are no feedback connections where outputs of the network are fed back into itself. In some cases, the neural network 400 can include a recurrent neural network, which can have loops that allow information to be carried across nodes while reading in input.

Information can be exchanged between nodes through node-to-node interconnections between the various layers. Nodes of the input layer 420 can activate a set of nodes in the first hidden layer 422a. For example, as shown, each of the input nodes of the input layer 420 is connected to each of the nodes of the first hidden layer 422a. The nodes of the first hidden layer 422a can transform the information of each input node by applying activation functions to the input node information. The information derived from the transformation can then be passed to and can activate the nodes of the next hidden layer 422b, which can perform their own designated functions. Example functions include convolutional, up-sampling, data transformation, and/or any other suitable functions. The output of the hidden layer 422b can then activate nodes of the next hidden layer, and so on. The output of the last hidden layer 422n can activate one or more nodes of the output layer 421, at which an output is provided. In some cases, while nodes in the neural network 400 are shown as having multiple output lines, a node can have a single output and all lines shown as being output from a node represent the same output value.

In some cases, each node or interconnection between nodes can have a weight that is a set of parameters derived from the training of the neural network 400. Once the neural network 400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 400 to be adaptive to inputs and able to learn as more and more data is processed.

The neural network 400 is pre-trained to process the features from the data in the input layer 420 using the different hidden layers 422a, 422b, through 422n in order to provide the output through the output layer 421.

In some cases, the neural network 400 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 400 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target−output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 400 can perform a backward pass by determining which inputs (weights) most contributed to the loss of the network, and can adjust the weights so that the loss decreases and is eventually minimized.

The neural network 400 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 400 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 5 is a diagram illustrating an example autonomous vehicle (AV) environment 500, according to some examples of the present disclosure. One of ordinary skill in the art will understand that, for AV environment 500 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 500 includes an AV 502, a data center 550, and a client computing device 570. The AV 502, the data center 550, and the client computing device 570 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 502 can navigate roadways without a human driver based on sensor signals generated by multiple sensor systems 504, 506, and 508. The sensor systems 504-508 can include one or more types of sensors and can be arranged about the AV 502. For instance, the sensor systems 504-508 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 504 can be a camera system, the sensor system 506 can be a LIDAR system, and the sensor system 508 can be a RADAR system. Other examples may include any other number and type of sensors.

The AV 502 can also include several mechanical systems that can be used to maneuver or operate the AV 502. For instance, the mechanical systems can include a vehicle propulsion system 530, a braking system 532, a steering system 534, a safety system 536, and a cabin system 538, among other systems. The vehicle propulsion system 530 can include an electric motor, an internal combustion engine, or both. The braking system 532 can include an engine brake, brake pads, actuators, and/or any other suitable componentry configured to assist in decelerating the AV 502. The steering system 534 can include suitable componentry configured to control the direction of movement of the AV 502 during navigation. The safety system 536 can include lights and signal indicators, a parking brake, airbags, and so forth. The cabin system 538 can include cabin temperature control systems, in-cabin entertainment systems, and so forth. In some examples, the AV 502 might not include human driver actuators (e.g., steering wheel, handbrake, foot brake pedal, foot accelerator pedal, turn signal lever, window wipers, etc.) for controlling the AV 502. Instead, the cabin system 538 can include one or more client interfaces (e.g., Graphical User Interfaces (GUIs), Voice User Interfaces (VUIs), etc.) for controlling certain aspects of the mechanical systems 530-538.

The AV 502 can include a local computing device 510 that is in communication with the sensor systems 504-508, the mechanical systems 530-538, the data center 550, and the client computing device 570, among other systems. The local computing device 510 can include one or more processors and memory, including instructions that can be executed by the one or more processors. The instructions can make up one or more software stacks or components responsible for controlling the AV 502; communicating with the data center 550, the client computing device 570, and other systems; receiving inputs from riders, passengers, and other entities within the AV's environment; logging metrics collected by the sensor systems 504-508; and so forth. In this example, the local computing device 510 includes a perception stack 512, a localization stack 514, a prediction stack 516, a planning stack 518, a communications stack 520, a control stack 522, an AV operational database 524, and an HD geospatial database 526, among other stacks and systems.

Perception stack 512 can enable the AV 502 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 504-508, the localization stack 514, the HD geospatial database 526, other components of the AV, and other data sources (e.g., the data center 550, the client computing device 570, third party data sources, etc.). The perception stack 512 can detect and classify objects and determine their current locations, speeds, directions, and the like. In addition, the perception stack 512 can determine the free space around the AV 502 (e.g., to maintain a safe distance from other objects, change lanes, park the AV, etc.). The perception stack 512 can identify environmental uncertainties, such as where to look for moving objects, flag areas that may be obscured or blocked from view, and so forth. In some examples, an output of the perception stack 512 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 514 can determine the AV's position and orientation (pose) using different methods from multiple systems (e.g., GPS, IMUs, cameras, LIDAR, RADAR, ultrasonic sensors, the HD geospatial database 526, etc.). For example, in some cases, the AV 502 can compare sensor data captured in real-time by the sensor systems 504-508 to data in the HD geospatial database 526 to determine its precise (e.g., accurate to the order of a few centimeters or less) position and orientation. The AV 502 can focus its search based on sensor data from one or more first sensor systems (e.g., GPS) by matching sensor data from one or more second sensor systems (e.g., LIDAR). If the mapping and localization information from one system is unavailable, the AV 502 can use mapping and localization information from a redundant system and/or from remote data sources.

Prediction stack 516 can receive information from the localization stack 514 and objects identified by the perception stack 512 and predict a future path for the objects. In some examples, the prediction stack 516 can output several likely paths that an object is predicted to take along with a probability associated with each path. For each predicted path, the prediction stack 516 can also output a range of points along the path corresponding to a predicted location of the object along the path at future time intervals along with an expected error value for each of the points that indicates a probabilistic deviation from that point.

Planning stack 518 can determine how to maneuver or operate the AV 502 safely and efficiently in its environment. For example, the planning stack 518 can receive the location, speed, and direction of the AV 502, geospatial data, data regarding objects sharing the road with the AV 502 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 502 from one point to another and outputs from the perception stack 512, localization stack 514, and prediction stack 516. The planning stack 518 can determine multiple sets of one or more mechanical operations that the AV 502 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 518 can select from multiple backup plans to carry out. For example, while preparing to change lanes to turn right at an intersection, another vehicle may aggressively cut into the destination lane, making the lane change unsafe. The planning stack 518 could have already determined an alternative plan for such an event. Upon its occurrence, it could help direct the AV 502 to go around the block instead of blocking a current lane while waiting for an opening to change lanes.

Control stack 522 can manage the operation of the vehicle propulsion system 530, the braking system 532, the steering system 534, the safety system 536, and the cabin system 538. The control stack 522 can receive sensor signals from the sensor systems 504-508 as well as communicate with other stacks or components of the local computing device 510 or a remote system (e.g., the data center 550) to effectuate operation of the AV 502. For example, the control stack 522 can implement the final path or actions from the multiple paths or actions provided by the planning stack 518. This can involve turning the routes and decisions from the planning stack 518 into commands for the actuators that control the AV's steering, throttle, brake, and drive unit.

Communications stack 520 can transmit and receive signals between the various stacks and other components of the AV 502 and between the AV 502, the data center 550, the client computing device 570, and other remote systems. The communications stack 520 can enable the local computing device 510 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 520 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 526 can store HD maps and related data of the streets upon which the AV 502 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 524 can store raw AV data generated by the sensor systems 504-508, stacks 512-522, and other components of the AV 502 and/or data received by the AV 502 from remote systems (e.g., the data center 550, the client computing device 570, etc.). In some examples, the raw AV data can include HD LIDAR point cloud data, image data, RADAR data, GPS data, and other sensor data that the data center 550 can use for creating or updating AV geospatial data or for creating simulations of situations encountered by AV 502 for future testing or training of various machine learning algorithms that are incorporated in the local computing device 510.

Data center 550 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 550 can include one or more computing devices remote to the local computing device 510 for managing a fleet of AVs and AV-related services. For example, in addition to managing the AV 502, the data center 550 may also support a ride-hailing service (e.g., a ridesharing service), a delivery service, a remote/roadside assistance service, street services (e.g., street mapping, street patrol, street cleaning, street metering, parking reservation, etc.), and the like.

Data center 550 can send and receive various signals to and from the AV 502 and the client computing device 570. These signals can include sensor data captured by the sensor systems 504-508, roadside assistance requests, software updates, ride-hailing/ridesharing pick-up and drop-off instructions, and so forth. In this example, the data center 550 includes a data management platform 552, an Artificial Intelligence/Machine Learning (AI/ML) platform 554, a simulation platform 556, a remote assistance platform 558, and a ride-hailing platform 560, and a map management platform 562, among other systems.

Data management platform 552 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 550 can access data stored by the data management platform 552 to provide their respective services.

The AI/ML platform 554 can provide the infrastructure for training and evaluating machine learning algorithms for operating the AV 502, the simulation platform 556, the remote assistance platform 558, the ride-hailing platform 560, the map management platform 562, and other platforms and systems. Using the AI/ML platform 554, data scientists can prepare data sets from the data management platform 552; select, design, and train machine learning models; evaluate, refine, and deploy the models; maintain, monitor, and retrain the models; and so on.

Simulation platform 556 can enable testing and validation of the algorithms, machine learning models, neural networks, and other development efforts for the AV 502, the remote assistance platform 558, the ride-hailing platform 560, the map management platform 562, and other platforms and systems. Simulation platform 556 can replicate a variety of driving environments and/or reproduce real-world scenarios from data captured by the AV 502, including rendering geospatial information and road infrastructure (e.g., streets, lanes, crosswalks, traffic lights, stop signs, etc.) obtained from a cartography platform (e.g., map management platform 562); modeling the behavior of other vehicles, bicycles, pedestrians, and other dynamic elements; simulating inclement weather conditions, different traffic scenarios; and so on.

Remote assistance platform 558 can generate and transmit instructions regarding the operation of the AV 502. For example, in response to an output of the AI/ML platform 554 or other system of the data center 550, the remote assistance platform 558 can prepare instructions for one or more stacks or other components of the AV 502.

Ride-hailing platform 560 can interact with a customer of a ride-hailing service via a ride-hailing application 572 executing on the client computing device 570. The client computing device 570 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 572. The client computing device 570 can be a customer's mobile computing device or a computing device integrated with the AV 502 (e.g., the local computing device 510). The ride-hailing platform 560 can receive requests to pick up or drop off from the ride-hailing application 572 and dispatch the AV 502 for the trip.

Map management platform 562 can provide a set of tools for the manipulation and management of geographic and spatial (geospatial) and related attribute data. The data management platform 552 can receive LIDAR point cloud data, image data (e.g., still image, video, etc.), RADAR data, GPS data, and other sensor data (e.g., raw data) from one or more AVs 502, Unmanned Aerial Vehicles (UAVs), satellites, third-party mapping services, and other sources of geospatially referenced data. The raw data can be processed, and map management platform 562 can render base representations (e.g., tiles (2D), bounding volumes (3D), etc.) of the AV geospatial data to enable users to view, query, label, edit, and otherwise interact with the data. Map management platform 562 can manage workflows and tasks for operating on the AV geospatial data. Map management platform 562 can control access to the AV geospatial data, including granting or limiting access to the AV geospatial data based on user-based, role-based, group-based, task-based, and other attribute-based access control mechanisms. Map management platform 562 can provide version control for the AV geospatial data, such as to track specific changes that (human or machine) map editors have made to the data and to revert changes when necessary. Map management platform 562 can administer release management of the AV geospatial data, including distributing suitable iterations of the data to different users, computing devices, AVs, and other consumers of HD maps. Map management platform 562 can provide analytics regarding the AV geospatial data and related data, such as to generate insights relating to the throughput and quality of mapping tasks.

In some embodiments, the map viewing services of map management platform 562 can be modularized and deployed as part of one or more of the platforms and systems of the data center 550. For example, the AI/ML platform 554 may incorporate the map viewing services for visualizing the effectiveness of various object detection or object classification models, the simulation platform 556 may incorporate the map viewing services for recreating and visualizing certain driving scenarios, the remote assistance platform 558 may incorporate the map viewing services for replaying traffic incidents to facilitate and coordinate aid, the ride-hailing platform 560 may incorporate the map viewing services into the client application 572 to enable passengers to view the AV 502 in transit en route to a pick-up or drop-off location, and so on.

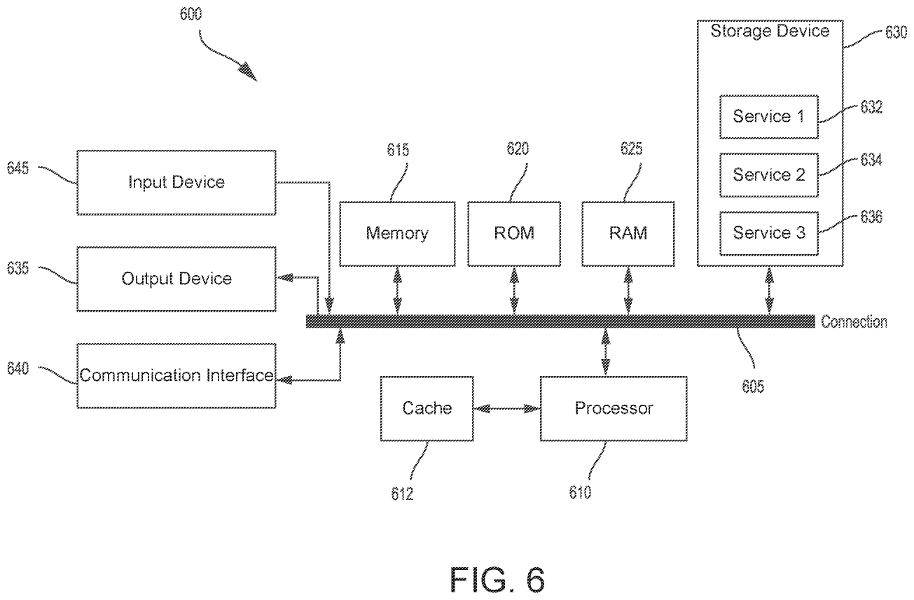

While the autonomous vehicle 502, the local computing device 510, and the autonomous vehicle environment 500 are shown to include certain systems and components, one of ordinary skill will appreciate that the autonomous vehicle 502, the local computing device 510, and/or the autonomous vehicle environment 500 can include more or fewer systems and/or components than those shown in FIG. 5. For example, the autonomous vehicle 502 can include other services than those shown in FIG. 5 and the local computing device 510 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 5. An illustrative example of a computing device and hardware components that can be implemented with the local computing device 510 is described below with respect to FIG. 6.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1. A method comprising: determining a longitudinal coordinate of a location within a multi-level structure and a latitudinal coordinate of the location within the multi-level structure; determining, based on map data, an altitude parameter of the location within the multi-level structure; determining, based on the longitudinal coordinate, the latitudinal coordinate, and the altitude parameter of the location, a route for an autonomous vehicle (AV) to travel to the location; determining one or more rules for vehicles in the multi-level structure based on at least one of a characteristic of a scene within the multi-level structure determined based on sensor data collected by the AV and one or more features of the scene determined based on the sensor data, and routing the AV to the location based on the one or more rules and the longitudinal coordinate, the latitudinal coordinate, and the altitude parameter of the location.

Aspect 2. The method of Aspect 1, wherein the location is within a particular level of the multi-level structure.

Aspect 3. The method of Aspect 1 or 2, wherein the map data comprises an indication of a level in the multi-level structure associated with the location, wherein the altitude parameter comprises the indication of the level associated with the location.

Aspect 4. The method of any of Aspects 1 to 3, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

Aspect 5. The method of any of Aspects 1 to 4, further comprising: determining a second parameter related to a parking rule at the location; and routing the AV to the location based on the one or more rules, the longitudinal coordinate, the latitudinal coordinate, the altitude parameter, and the second parameter of the location.

Aspect 6. The method of any of Aspects 1 to 5, wherein routing the AV to the location based on the longitudinal coordinate, the latitudinal coordinate, and the altitude parameter of the location further comprises: navigating, using sensor data collected by one or more sensors of the AV, the AV to the location via one or more ramps from a level of the multi-level structure to a different level of the multi-level structure, wherein the different level of the multi-level structure is associated with the location.

Aspect 7. The method of any of Aspects 1 to 6, wherein the one or more rules comprise a directionality of traffic within one or more portions of the multi-level structure, wherein the one or more portions of the multi-level structure comprise at least one of one or more ramps and one or more lanes, the method further comprising determining the directionality of traffic within the one or more portions based on at least one of image data within the sensor data, light detection and ranging data within the sensor data, and radio detection and sensing data within the sensor data.

Aspect 8. A system for routing an autonomous vehicle (AV) to a location comprising: at least one memory; and at least one processor coupled to the at least one memory, the at least one processor configured to: determine a longitudinal coordinate of a location within a multi-level structure and a latitudinal coordinate of the location within the multi-level structure; determine, based on map data, an altitude parameter of the location within the multi-level structure; determine, based on the longitudinal coordinate, the latitudinal coordinate, and the altitude parameter of the location, a route for an autonomous vehicle (AV) to travel to the location; determine one or more rules for vehicles in the multi-level structure based on at least one of a characteristic of a scene within the multi-level structure determined based on sensor data collected by the AV and one or more features of the scene determined based on the sensor data, and route the AV to the location based on the one or more rules and the longitudinal coordinate, the latitudinal coordinate, and the altitude parameter of the location.

Aspect 9. The system of Aspect 8, wherein the location is within a particular level of the multi-level structure.

Aspect 10. The system of Aspect 8 or 9, wherein the map data comprises an indication of a level in the multi-level structure associated with the location, wherein the altitude parameter comprises the indication of the level associated with the location.

Aspect 11. The system of any of Aspects 8 to 10, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

Aspect 12. The system of any of Aspects 8 to 11, wherein the at least one processor is further configured to: determine a second parameter related to a parking rule at the location; and route the AV to the location based on the one or more rules, the longitudinal coordinate, the latitudinal coordinate, the altitude parameter, and the second parameter of the location.

Aspect 13. The system of any of Aspects 8 to 12, wherein the at least one processor configured to route the AV to the location based on the longitudinal coordinate, the latitudinal coordinate, and the altitude parameter of the location is further configured to: navigate, using sensor data collected by one or more sensors of the AV, the AV to the location via one or more ramps from a level of the multi-level structure to a different level of the multi-level structure, wherein the different level of the multi-level structure is associated with the location.

Aspect 14. The system of any of Aspects 8 to 13, wherein the one or more rules comprise a directionality of traffic within one or more portions of the multi-level structure, wherein the one or more portions of the multi-level structure comprise at least one of one or more ramps and one or more lanes, the method further comprising determining the directionality of traffic within the one or more portions based on at least one of image data within the sensor data, light detection and ranging data within the sensor data, and radio detection and sensing data within the sensor data.

Aspect 15. A non-transitory computer-readable storage medium for routing an autonomous vehicle (AV) to a location comprising at least one instruction for causing a computer or processor to: determine a longitudinal coordinate of a location within a multi-level structure and a latitudinal coordinate of the location within the multi-level structure; determine, based on map data, an altitude parameter of the location within the multi-level structure; determine, based on the longitudinal coordinate, the latitudinal coordinate, and the altitude parameter of the location, a route for an autonomous vehicle (AV) to travel to the location; determine one or more rules for vehicles in the multi-level structure based on at least one of a characteristic of a scene within the multi-level structure determined based on sensor data collected by the AV and one or more features of the scene determined based on the sensor data, and route the AV to the location based on the one or more rules and the longitudinal coordinate, the latitudinal coordinate, and the altitude parameter of the location.

Aspect 16. The non-transitory computer-readable storage medium of Aspect 15, wherein the location is within a particular level of the multi-level structure.

Aspect 17. The non-transitory computer-readable storage medium of Aspect 15 or 16, wherein the map data comprises an indication of a level in the multi-level structure associated with the location, wherein the altitude parameter comprises the indication of the level associated with the location.

Aspect 18. The non-transitory computer-readable storage medium of any of Aspects 15 to 17, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

Aspect 19. The non-transitory computer-readable storage medium of any of Aspects 15 to 18, wherein the at least one instruction further causes a computer or processor to: determine a second parameter related to a parking rule at the location; and route the AV to the location based on the one or more rules, the longitudinal coordinate, the latitudinal coordinate, the altitude parameter, and the second parameter of the location.

Aspect 20. wherein the at least one instruction causing the computer or processor to route the AV to the location based on the longitudinal coordinate, the latitudinal coordinate, and the altitude parameter of the location further causes the computer or processor to: navigate, using sensor data collected by one or more sensors of the AV, the AV to the location via one or more ramps from a level of the multi-level structure to a different level of the multi-level structure, wherein the different level of the multi-level structure is associated with the location.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
determining a longitudinal coordinate of a location within a multi-level structure and a latitudinal coordinate of the location within the multi-level structure;
determining, based on map data, an altitude parameter of the location within the multi-level structure;
determining, based on the longitudinal coordinate, the latitudinal coordinate, and the altitude parameter of the location, a route for an autonomous vehicle (AV) to travel to the location;
determining one or more rules for vehicles in the multi-level structure based on at least one of a characteristic of a scene within the multi-level structure determined based on sensor data collected by the AV and one or more features of the scene determined based on the sensor data, and
routing the AV to the location based on the one or more rules and the longitudinal coordinate, the latitudinal coordinate, and the altitude parameter of the location.

2. The method of claim 1, wherein the location is within a particular level of the multi-level structure.

3. The method of claim 1, wherein the map data comprises an indication of a level in the multi-level structure associated with the location, wherein the altitude parameter comprises the indication of the level associated with the location.

4. The method of claim 1, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

5. The method of claim 1, further comprising:
determining a second parameter related to a parking rule at the location; and
routing the AV to the location based on the one or more rules, the longitudinal coordinate, the latitudinal coordinate, the altitude parameter, and the second parameter of the location.

6. The method of claim 1, wherein routing the AV to the location based on the longitudinal coordinate, the latitudinal coordinate, and the altitude parameter of the location further comprises:
navigating, using sensor data collected by one or more sensors of the AV, the AV to the location via one or more ramps from a level of the multi-level structure to a different level of the multi-level structure, wherein the different level of the multi-level structure is associated with the location.

7. The method of claim 1, wherein the one or more rules comprise a directionality of traffic within one or more portions of the multi-level structure, wherein the one or more portions of the multi-level structure comprise at least one of one or more ramps and one or more lanes, the method further comprising determining the directionality of traffic within the one or more portions based on at least one of image data within the sensor data, light detection and ranging data within the sensor data, and radio detection and sensing data within the sensor data.

8. A system for routing an autonomous vehicle (AV) to a location comprising:
at least one memory; and
at least one processor coupled to the at least one memory, the at least one processor configured to:
determine a longitudinal coordinate of a location within a multi-level structure and a latitudinal coordinate of the location within the multi-level structure;
determine, based on map data, an altitude parameter of the location within the multi-level structure;
determine, based on the longitudinal coordinate, the latitudinal coordinate, and the altitude parameter of the location, a route for an autonomous vehicle (AV) to travel to the location;
determine one or more rules for vehicles in the multi-level structure based on at least one of a characteristic of a scene within the multi-level structure determined based on sensor data collected by the AV and one or more features of the scene determined based on the sensor data, and
route the AV to the location based on the one or more rules and the longitudinal coordinate, the latitudinal coordinate, and the altitude parameter of the location.

9. The system of claim 8, wherein the location is within a particular level of the multi-level structure.

10. The system of claim 8, wherein the map data comprises an indication of a level in the multi-level structure associated with the location, wherein the altitude parameter comprises the indication of the level associated with the location.

11. The system of claim 8, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

12. The system of claim 8, wherein the at least one processor is further configured to:
determine a second parameter related to a parking rule at the location; and
route the AV to the location based on the one or more rules, the longitudinal coordinate, the latitudinal coordinate, the altitude parameter, and the second parameter of the location.

13. The system of claim 8, wherein the at least one processor configured to route the AV to the location based on the longitudinal coordinate, the latitudinal coordinate, and the altitude parameter of the location is further configured to:
navigate, using sensor data collected by one or more sensors of the AV, the AV to the location via one or more ramps from a level of the multi-level structure to a different level of the multi-level structure, wherein the different level of the multi-level structure is associated with the location.

14. The system of claim 8, wherein the one or more rules comprise a directionality of traffic within one or more portions of the multi-level structure, wherein the one or more portions of the multi-level structure comprise at least one of one or more ramps and one or more lanes, wherein the at least one processor is further configured to determine the directionality of traffic within the one or more portions based on at least one of image data within the sensor data, light detection and ranging data within the sensor data, and radio detection and sensing data within the sensor data.

15. A non-transitory computer-readable storage medium for routing an autonomous vehicle (AV) to a location comprising at least one instruction for causing a computer or processor to:
determine a longitudinal coordinate of a location within a multi-level structure and a latitudinal coordinate of the location within the multi-level structure;
determine, based on map data, an altitude parameter of the location within the multi-level structure;
determine, based on the longitudinal coordinate, the latitudinal coordinate, and the altitude parameter of the location, a route for an autonomous vehicle (AV) to travel to the location;
determine one or more rules for vehicles in the multi-level structure based on at least one of a characteristic of a scene within the multi-level structure determined based on sensor data collected by the AV and one or more features of the scene determined based on the sensor data, and
route the AV to the location based on the one or more rules and the longitudinal coordinate, the latitudinal coordinate, and the altitude parameter of the location.

16. The non-transitory computer-readable storage medium of claim 15, wherein the location is within a particular level of the multi-level structure.

17. The non-transitory computer-readable storage medium of claim 15, wherein the map data comprises an indication of a level in the multi-level structure associated with the location, wherein the altitude parameter comprises the indication of the level associated with the location.

18. The non-transitory computer-readable storage medium of claim 15, wherein the at least one of the characteristic of the scene and the one or more features of the scene comprises at least one of a direction of travel of one or more vehicles in the multi-level structure, a behavior of the one or more vehicles, a behavior of one or more pedestrians, a configuration of one or more lanes within the multi-level structure, one or more objects in the multi-level structure, and a visual cue associated with the sensor data.

19. The non-transitory computer-readable storage medium of claim 15, wherein the at least one instruction further causes a computer or processor to:
determine a second parameter related to a parking rule at the location; and
route the AV to the location based on the one or more rules, the longitudinal coordinate, the latitudinal coordinate, the altitude parameter, and the second parameter of the location.

20. The non-transitory computer-readable storage medium of claim 15, wherein the at least one instruction causing the computer or processor to route the AV to the location based on the longitudinal coordinate, the latitudinal coordinate, and the altitude parameter of the location further causes the computer or processor to:
navigate, using sensor data collected by one or more sensors of the AV, the AV to the location via one or more ramps from a level of the multi-level structure to a different level of the multi-level structure, wherein the different level of the multi-level structure is associated with the location.
